(19) United States
(12) Patent Application Publication
(10) Pub. No.: US 2009/0328147 A1
(43) Pub. Date: Dec. 31, 2009

(54) EAP BASED CAPABILITY NEGOTIATION AND FACILITATION FOR TUNNELING EAP METHODS

(75) Inventors: Mudit Goel, Redmond, WA (US); Yue Luo, Redmond, WA (US); Ambrish Verma, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/163,540

(22) Filed: Jun. 27, 2008

(51) Int. Cl. H04L 9/32

(52) U.S. Cl. 726/3

(57) ABSTRACT

Capability negotiation during a PEAP transaction between two end points in a network is performed by initiating EAP capability negotiation methods. A first end point that desires to use a specific capability during a PEAP transaction initiates capability negotiation method requesting the specific capability. Upon receiving the request for the specific capability, a second end point performs the desired capability if an outer method employed in the PEAP transaction supports the specific capability. If the outer method does not support the desired capability, the receiver responds to the first end point with a negative acknowledgment. In other embodiments, if the outer method does not support the desired capability, the desired capability may still be performed if it is supported by an inner method. In such instances, an inner wrapper method is employed in the PEAP transaction to maintain and perform the capability.

### BACKGROUND

Tunneling Extensible Authentication Protocol (“EAP”) methods are commonly used to perform authentication between two end points in a network, such as between a sender and a receiver or a client and a server. Tunneling EAP methods generally consists of two phases, a first phase in which a method (outer method) is used to establish a secure communication tunnel between two end points. In the second phase, authentication is performed. The authentication method is determined using standard EAP method negotiation. However, there are many different versions of inner and outer EAP methods, each of which may support different capabilities.

In order to support new capabilities, the EAP method versions supported by end points must be updated. In certain circumstances, the capabilities of the outer EAP method may need to be updated. However, in many instances the EAP outer method cannot be updated because a programmer does not have access to the source code or the updates would require changes to the EAP standard, which can be difficult and time consuming. It is with respect to this general environment that embodiments of the present disclosure have been contemplated.

### SUMMARY

Embodiments of the present disclosure relate to systems and methods for performing capability negotiation with Extensible Authentication Protocol (“EAP”) methods used with tunneling EAP methods. One example tunneling EAP method is Protected Extensible Authentication (“PEAP”). Embodiments of the present disclosure are illustrated with respect to PEAP; however, one of skill in the art will appreciate that the methods and systems disclosed herein are applicable to any type of tunneling EAP methods. Embodiments of the present invention relate to providing a number of EAP methods for negotiating capabilities supported by the end points involved in an EAP tunneling transaction, such as a PEAP transaction. After the establishment of the outer tunnel, a sender generates an EAP capability negotiation method that is used during the negotiation of the inner EAP method. The EAP capability negotiation method relates to a specific capability. For example, the capability negotiation method may relate to a fragmentation capability. The sender initiates the capability negotiation method and sends a request to the receiver to perform the negotiated capability. If the receiver supports the negotiated capability, it may respond by performing the negotiated capability or by sending an acknowledgement indicating the ability to perform the negotiated capability. If the receiver does not support the negotiated capability, for example, the version of the outer method supported by the receiver does not support a desired capability, it may respond with a negative acknowledgment (“NAK”) listing EAP capability methods that it supports. The sender uses the NAK to determine that the receiver does not support the negotiated capability and also as an indication of which capabilities are supported by the receiver.

In another embodiment, the sender may perform the negotiated capability even though the secure outer tunnel created by the outer method does not support the negotiated capability. In embodiments, the sender may generate a wrapper inner EAP method that is compatible with the receiver's EAP capability. The wrapper inner EAP method acts as a tunnel within the outer EAP method to perform capabilities not supported by the outer method that the receiver employs. For example, if a receiver's outer method does not support the chaining of multiple authentication methods, the sender may generate a wrapper inner EAP method which is compliant with the capability supported by the receiver's outer method. The sender may then chain multiple authentication methods within the wrapper inner EAP method.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Embodiments of the present disclosure may be more readily described by reference to the accompanying drawings in which like numbers refer to like items and in which:

FIG. 1A illustrates and embodiment of a system 10 for determining capabilities of a device during a PEAP transaction.

FIG. 1B an embodiment of a system 24 for performing an unsupported capability using an inner wrapper method is illustrated.

FIG. 2 is a flow chart representing an embodiment of a method 200 for initiating an EAP method to perform capability negotiations between devices in a PEAP transaction.

FIG. 3 is a flow chart representing an embodiment of a method 200 for responding to an EAP capability negotiation.

FIG. 4 is a flow chart representing an embodiment of a method 400 for performing unsupported capability using a wrapper method.

FIG. 5 is a flow chart representing an embodiment of a method 500 for chaining multiple authentication requests.

FIG. 6 is a flow chart representing an embodiment of a method 600 determining the capability supported by a receiving device and performing any unsupported capability.

FIG. 7 is a functional diagram illustrating a computer environment and computer system 700 operable to execute embodiments of the present disclosure.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

Embodiments of the present invention relate to determining capabilities supported by a receiver involved in a tunneling EAP transaction. Although specific embodiments are illustrated with respect to PEAP, one of skill in the art will appreciate that the use of PEAP is for illustrative purposes only and that the disclose systems and methods are operable with any tunneling EAP methods. After creating a secure tunnel between a sender and a receiver, the sender initiates an EAP capability negotiation method. In embodiments, the capability negotiation method relates to a specific capability. For example, the capability negotiation method may relate to fragmentation. The sender uses the capability negotiation method to send a request to the receiver to perform the negotiated capability. If the receiver supports the negotiated capability, it may respond by performing the capability. If the receiver does not support the negotiated capability, it may respond with a NAK. The sender uses the NAK to determine that the receiver does not support the negotiated capability. In another example, the capability negotiation method may relate to negotiating the specific capabilities of an outer method employed by one of the parties to an EAP transaction. One of skill in the art will appreciate that while particular illustrations may describe the capability negotiation as determining the specific capabilities of a device involved in a PEAP transaction, the capabilities of the device depends upon the capabilities of the EAP methods employed by the device.

The use of the capability negotiation method provides a safe approach to detecting whether a device involved in a PEAP transaction supports a capability. Because both parties to the PEAP transaction are compliant with the EAP standard, the capability negotiation method may be used to detect the capabilities of one of the devices without the possibility that the negotiation will cause the devices to choke, crash, or misbehave. Additionally, the EAP capability negotiation method allows for the detection of capabilities without having to change the protocol version number or using reserved bits defined by the protocol. This ensures that any added capabilities will not conflict with future versions of the protocol which may define different uses for the reserved bits.

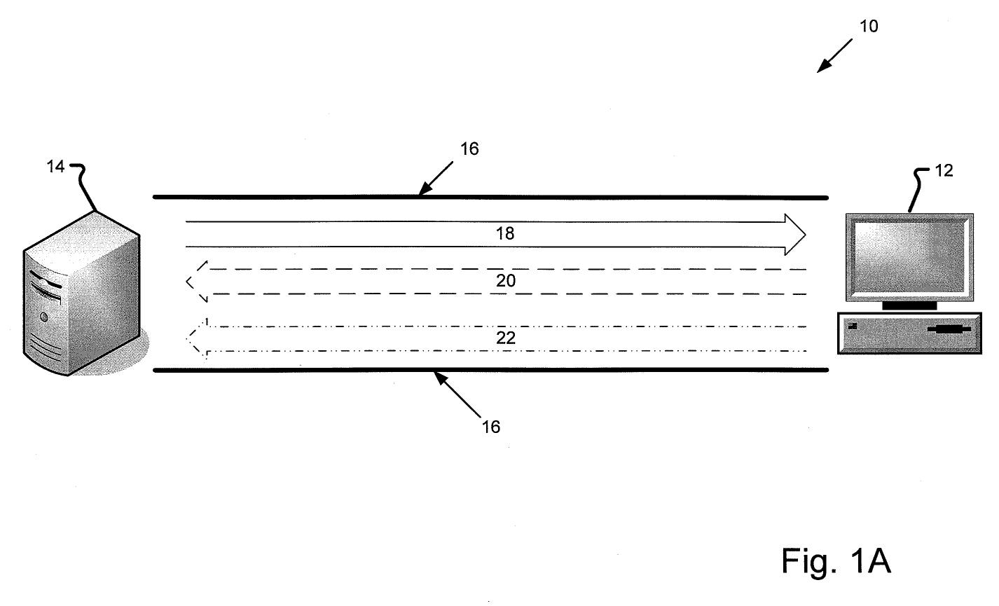

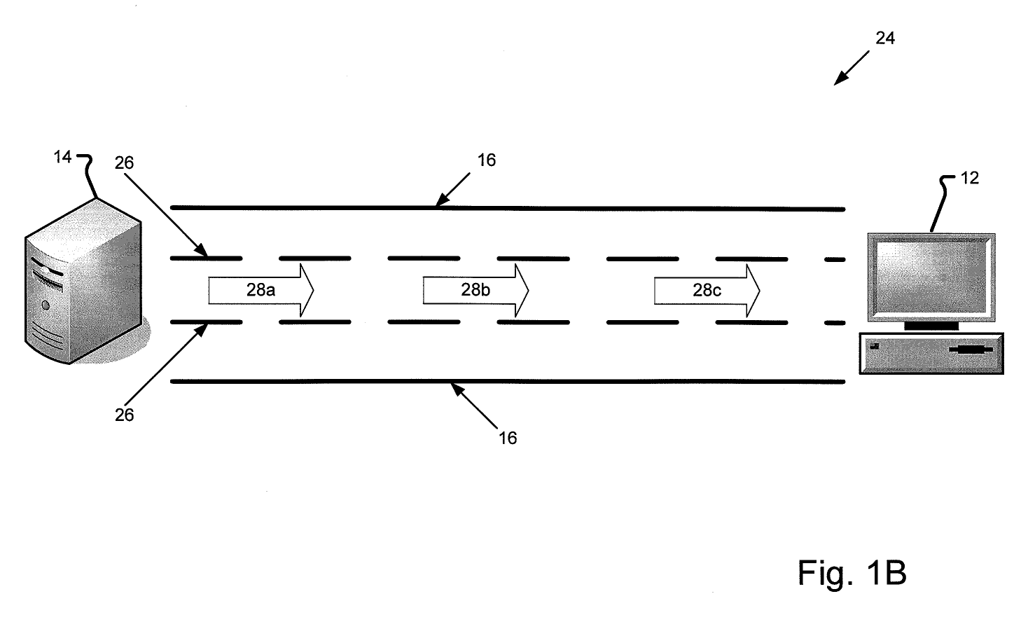

Turning now to the figures, FIGS. 1-7 illustrate example embodiments of the present disclosure. Embodiments of the present disclosure are illustrated with respect to PEAP; however, one of skill in the art will appreciate that the methods and systems disclosed herein are applicable to any type of tunneling EAP methods.

FIG. 1A illustrates an embodiment of a system 10 for determining capabilities of a device during a PEAP transaction. A PEAP transaction is initiated between two end points; in FIG. 1A illustrated as a sender (client 12) and a receiver (server 14). In other embodiments, the server 14 may be the sender and client 12 the receiver. The PEAP transaction creates a secure tunnel 16 using an outer method to facilitate the secure transport of inner EAP authentication methods. During the PEAP transaction, one of the parties to the transaction may desire to employ a specific capability, e.g., fragmentation. For example, the server 14 may not be aware of the capabilities supported by the version of the EAP methods employed by client 12. In order to determine whether the client 12 supports the desired capability, the server 14 may generate and send a capability negotiation request, as illustrated by communication 18.

If the client 12 is able to perform the desired capability, the client 12 responds with communication 20. In one embodiment, communication 20 may be an acknowledgment that the client 12 supports the desired capability. In yet another embodiment, communication 20 may include additional negotiation packets to define the specific parameters to be employed in performing the desired capability. For example, if the server 14 desires to apply fragmentation, client 12 may respond with communication 20 by detailing instructions and/or parameters regarding the capability, e.g., maximum size of a fragment, or any other detail related to fragmentation. One of skill in the art will appreciate that in other embodiments, the parameters will relate to other types of capabilities that are being negotiated using the additional negotiation packets.

If the client 12 is unable to perform the desired capability, the client 12 responds with a Negative Acknowledgment (“NAK”), as illustrated by communication 22. The NAK of communication 22 may contain a list of capabilities supported by the client 12. In such embodiments, server 14 may use the list to determine which capabilities are supported by client 12 and may use these capabilities to complete the PEAP transaction. In some embodiments, the NAK contains only a partial list of capabilities that client 12 supports. In those embodiments, the server 14 cannot determine all of the capabilities supported by the client 12 by examining the NAK; however, the server 14 can still determine that client 12 does not support the desired capability.

Referring now to FIG. 1B, an embodiment of a system 24 for performing an unsupported capability using an inner wrapper method is illustrated. Again, a PEAP transaction is initiated between a client 12 and a server 14. A secure tunnel 16 is created to facilitate the secure transport of PEAP inner methods. Server 14 desires to perform a capability that is not supported by the outer method used to create tunnel 16. Server 14 creates an inner wrapper method, illustrated by dashed lines 26. The inner wrapper method 26 is supported by server 14, the outer method used to create tunnel 16, and client 12. Inner wrapper method 26 acts as a tunnel for multiple inner methods 28(a-c). Multiple inner methods 28(a-c) may perform the unsupported capabilities (e.g., fragmentation, chaining, or any other capability not supported by the outer method used to create tunnel 16) under the control and management of inner wrapper method 26. Using inner wrapper method 26, server 14 is able to perform capabilities that the EAP methods employed by client 12 do not otherwise support.

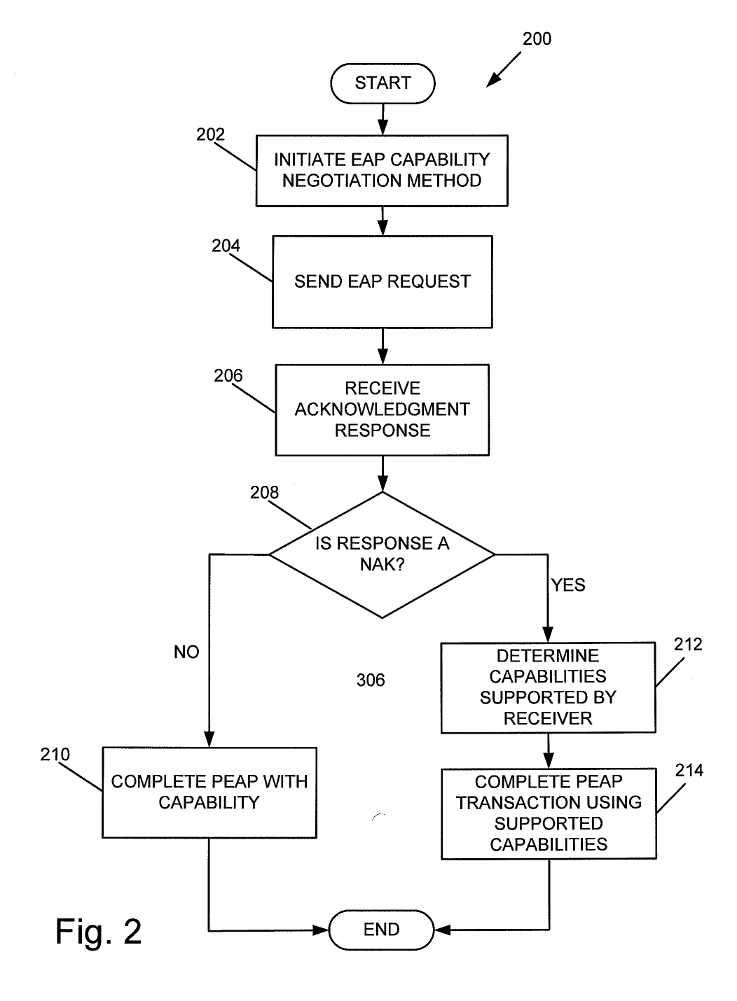

FIG. 2 is a flow chart representing an embodiment of a method 200 for initiating an EAP method to perform capability negotiations between a sender and a receiver in a PEAP transaction. In embodiments, method 200 is implemented in a system such as described above in FIG. 1A. Method 200 begins at operation 202, where a sender attempts to negotiate the capabilities of an inner EAP method, after the establishment of PEAP's outer tunnel. In embodiments, the capability negotiation method relates to a specific capability. For example, in embodiments, the capability negotiation method relates to fragmentation. If the sender is generating large EAP packets, it may want to break these packets into smaller pieces for transmission. The receiver may rebuild these smaller packets upon receiving them. However, not all EAP versions provide EAP methods that support fragmentation. In such situations, a sender must determine whether the receiver supports fragmentation before breaking the packets into smaller sizes by initiating a capability negotiation method related to fragmentation.

Flow proceeds to operation 204 where the sending device sends an EAP request to a receiver. The EAP request may be a request to utilize a specific capability. In another embodiment, the request may simply be used to verify that the receiver is capable of performing the specific capability. In such embodiments, the request may take the form of an empty request. For example, the request may simply specify that fragmentation is desired. In other embodiments, the request may consist of more complex instructions. For example, referring to the fragmentation example, the request may also perform further functionality, such as negotiating maximum fragment size, etc. While the above examples relate to fragmentation capabilities, one of skill in the art will appreciate that any other type of capability may be negotiated.

Flow then proceeds to operation 206, where the sender receives a response from the receiver. At operation 208, the sender determines whether the response is a negative acknowledgment (“NAK”) from the receiver. If at operation 208, a determination is made that the response is not a NAK, flow proceeds to operation 210, where the PEAP transaction is completed using the capability negotiated. However, if at operation 208 a determination is made that the response is a NAK indicating that the receiver does not support the requested capability, then it may be necessary to discover what capabilities the receiver supports in order to complete the PEAP transaction. Accordingly, at operation 212 the sender determines the capabilities of the receiver. In one embodiment, the sender determines the capabilities of the receiver by sending multiple requests to the receiver until the receiver performs a requested capability or sends a response indicating that a capability is supported. In another embodiment, the NAK lists the capabilities supported by the receiver. In such an embodiment, the sender determines the supported capabilities of the receiver by examining the NAK. In other embodiments, the NAK may contain a partial list of capabilities that the receiver supports. In such situations, the sender cannot determine all of the capabilities supported by the receiver by examining the NAK; however, the sender can still determine that the receiver does not support the desired capability. Once the sending device determines the supported capabilities of the receiver that are compatible with the capabilities of the sender, flow proceeds to operation 214, where the PEAP transaction is completed using capabilities supported by both the sender and receiver.

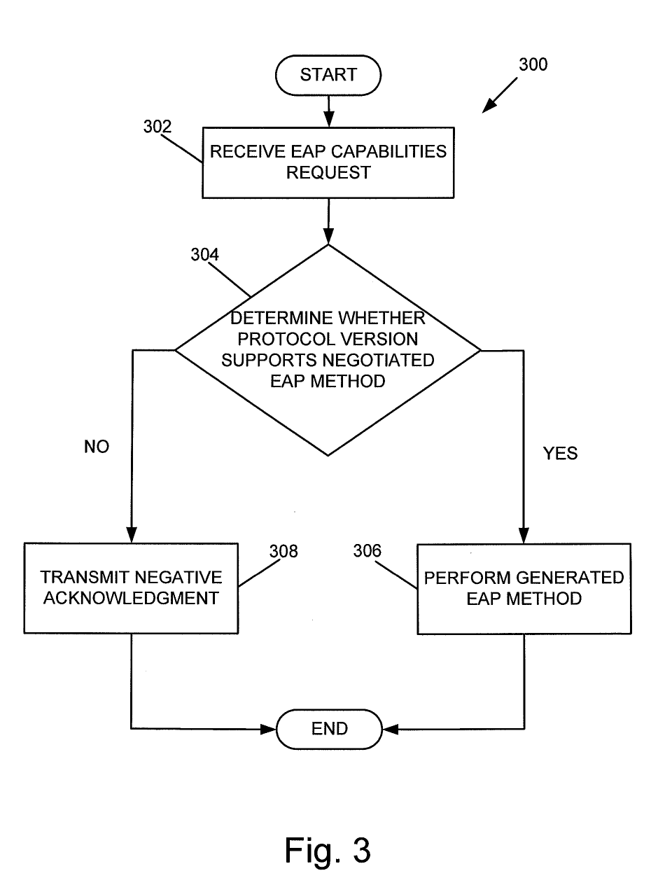

Referring now to FIG. 3, a flow chart is illustrated representing an embodiment of a method 300 for responding to an EAP capability negotiation request. Flow begins at operation 302, where a receiver receives the EAP capability negotiation method request. In embodiments, the receiver receives a request that requires an acknowledgement that it supports a capability. In another embodiment, the receiver may receive a request that requires the performance of a specific capability such as fragmenting a packet. In yet another embodiment, the receiver may receive a request that requires it to understand a specific capability, such as the ability to combine fragmented packets.

Flow proceeds to decision operation 304, where the receiver determines whether or not it supports the desired capability. In embodiments, the receiver may support the capability. For example, the receiver may be using the same version of an EAP protocol as the sender requesting the capability. In other embodiments, the receiver may be using a different version of the protocol than is being used by the sender; however the version used by the receiver may still support the desired capability. In embodiments, if the receiver supports the desired capability, upon receiving the capability negotiation method the receiver understands the capability negotiation method (e.g., the receiver recognizes the desired capability requested in the capability negotiation or recognizes that the capability negotiation method is requesting the desired capability). If the receiver supports the capability, flow branches YES to operation 306, wherein the receiver performs the desired capability. In another embodiment, the receiver responds with a message for negotiating specific parameters of the desired capability. For example, the receiver may respond with a message specifying packet size, number of packets, etc. if the desired capability is fragmentation.

If the receiver does not support the desired capability, then, in embodiments, it will not understand the capability negotiation method request. In other embodiments, the receiver may understand the capability negotiation method request; however the receiver may not support the desired capability. In such embodiments, flow branches NO to operation 308. At operation 308, the receiver responds to the request with a negative acknowledgement (“NAK”). In embodiments, the receiver responds with a Legacy NAK or an Expanded NAK. In other embodiments, the NAK lists the capabilities supported by the device. In such embodiments, the list may contain a complete list of supported capabilities or a partial list of supported capabilities.

In embodiments, the methods detailed in FIGS. 2-3 are used to determine which capabilities are supported by two different end points, e.g., a sender and a receiver, in a PEAP transaction. In embodiments, the disclosed methods are used to determine whether a specific capability is supported, e.g., fragmentation. In other embodiments, the methods may be employed to determine a list of capabilities supported by devices in a PEAP transaction by examining a NAK generated in response to a capabilities negotiation method. While specific embodiments of the disclosure thus far have been described with regard to a PEAP transaction, one of skill in the art will appreciate that the disclosed methods may be used with any type of Extensible Authentication Protocol transaction and is not necessarily limited to a PEAP transaction.

In another embodiment, a sender may perform a capability even though the outer method employed in the PEAP transaction does not support the capability. In embodiments, the sender may generate an inner wrapper EAP method that is compatible with the outer method. The wrapper method acts as a tunnel within the inner EAP method to perform a capability not supported by the outer method. For example, if the outer method employed in a PEAP transaction does not support the chaining of multiple authentication methods, the sender may generate a wrapper method which is compliant with the capability supported by the outer method. The sender may then chain multiple authentication methods within the wrapper method.

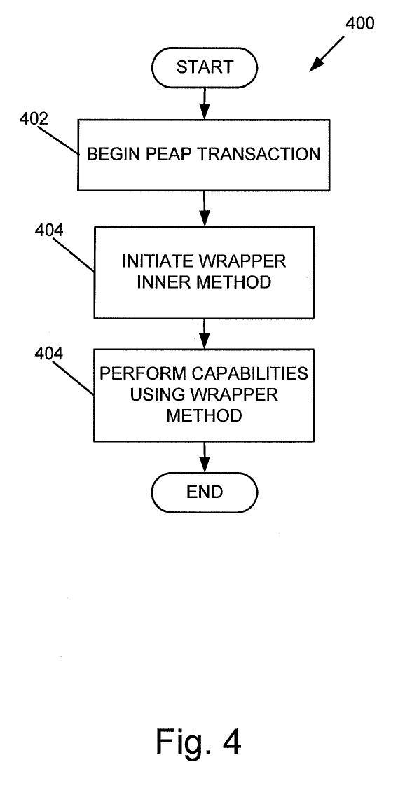

Referring now to FIG. 4, a flow chart representing an embodiment of a method 400 for performing unsupported capabilities using an inner wrapper method is illustrated. Flow begins at operation 402, where a PEAP transaction is initiated between two end points, e.g., a client and a server. One of skill in the art will appreciate that the PEAP transaction is only an example and any transaction that uses the Extensible Authentication Protocol may appropriately use method 400. A sender determines that the outer method does not support a desired capability. This may be done, for example, by using the capability negotiation methods described with respect to FIGS. 2 and 3. Flow then proceeds to operation 404 where the sender initiates an inner wrapper method. The inner wrapper method acts as a tunnel in which other methods, some of which may not be supported by the outer method, may be executed. In embodiments, the inner wrapper method provides the necessary support and transport for the other methods. Flow then proceeds to operation 406, where the desired capabilities are performed using the inner wrapper method. Using the inner wrapper method, the sender is able to perform capabilities even though they are not supported by the outer method employed in the PEAP transaction. In such embodiments, the outer method of PEAP, used to establish the secure tunnel, operates upon the inner wrapper method as if the inner wrapper method were a normal inner EAP method.

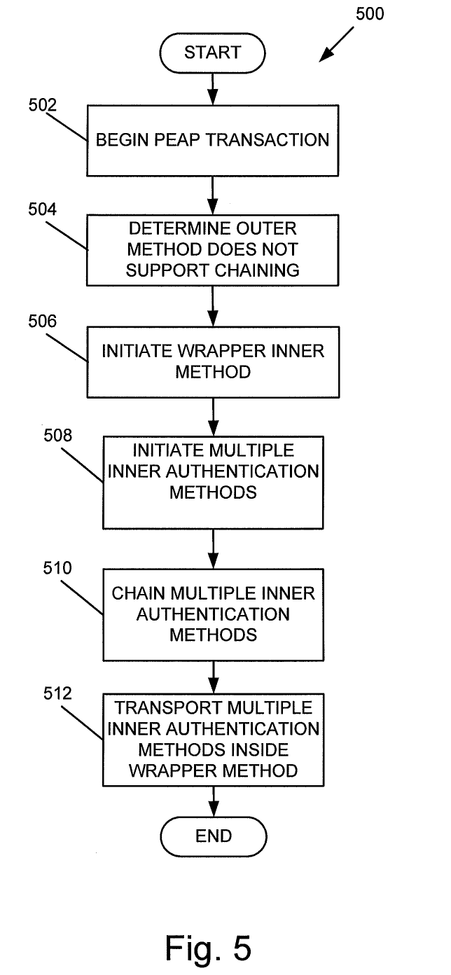

Referring now to FIG. 5, a flow chart representing an embodiment of a method 500 for chaining multiple authentication requests is illustrated. More specifically, FIG. 5 illustrates an embodiment in which the multiple inner methods may be chained together, even though the outer method in a PEAP transaction does not support the chaining of inner methods. In embodiments, inner methods are chained together by combining multiple inner EAP methods within a single outer EAP method using an inner wrapper method. Flow begins at operation 502, where a PEAP transaction is initiated between two end points, e.g., a client and a server.

Flow proceeds to operation 504, where the sender determines that the outer method does not support the chaining of multiple EAP methods. This may be done, for example, by using the methods described with respect to FIGS. 2 and 3. However, the embodiment illustrated in FIG. 5 allows for the chaining of multiple EAP methods even if the outer method does not support chaining.

Flow proceeds to operation 506, where an inner wrapper method is initiated. In embodiments, the inner wrapper method is initiated according to the method detailed with respect to FIG. 4. In embodiments, the inner wrapper method conforms to the outer EAP methods employed in a PEAP transaction. For example, the inner wrapper method conforms to the EAP protocol version supported by the outer method. As previously detailed with respect to FIG. 4, the inner wrapper method acts as a tunnel in which capabilities may be utilized.

Flow proceeds to operation 508, where multiple inner EAP methods are initiated. In embodiments, these methods may be used to perform authentication. In other embodiments, the multiple inner EAP methods may be used to perform other functions, e.g., fragmentation. In embodiments, the multiple inner EAP methods are generated such that they can be chained together in a PEAP transaction. While the illustrated embodiment describes initiating the wrapper method before initiating the multiple inner methods, one of skill in the art will readily appreciate that these methods may be initiated in any order

Flow then proceeds to operation 510, where the multiple inner EAP methods are chained together. In one embodiment, the multiple inner EAP methods may be chained by the inner wrapper method. In another embodiment, the multiple inner EAP methods may be chained by a a different method or process. The chaining of the multiple inner EAP methods has been described as a discreet step for illustrative purposes. One of skill in the art will appreciate that the multiple inner EAP methods may be simultaneously chained as they are transported by the inner wrapper method, as is described with respect to operation 512.

Flow then proceeds to operation 512 where the chained multiple inner EAP methods are transported inside the inner wrapper method. In embodiments, the inner wrapper method completely manages the chained inner methods. For example, the inner wrapper method may supply the chained inner methods with any data or functions needed for the chained methods to be performed. In other embodiments, the inner wrapper method may also perform the chaining of the multiple inner EAP methods, as described in operation 510. As described with respect to FIG. 5, method 500 may be employed to perform chaining of multiple inner methods even though the outer method employed a PEAP transaction does not support such chaining. While FIG. 5 has been described with regard to the specific capability of chaining multiple EAP methods, one of skill in the art will appreciate that method 500 may be employed to execute other capabilities not supported by the outer method employed in a PEAP transaction.

One of skill in the art will appreciate that the embodiments described with respect to FIG. 5 allows for the use of additional capabilities without updating the outer EAP method supported by either end point in a PEAP transaction. These methods may be employed to add any type of additional capability to the EAP transaction.

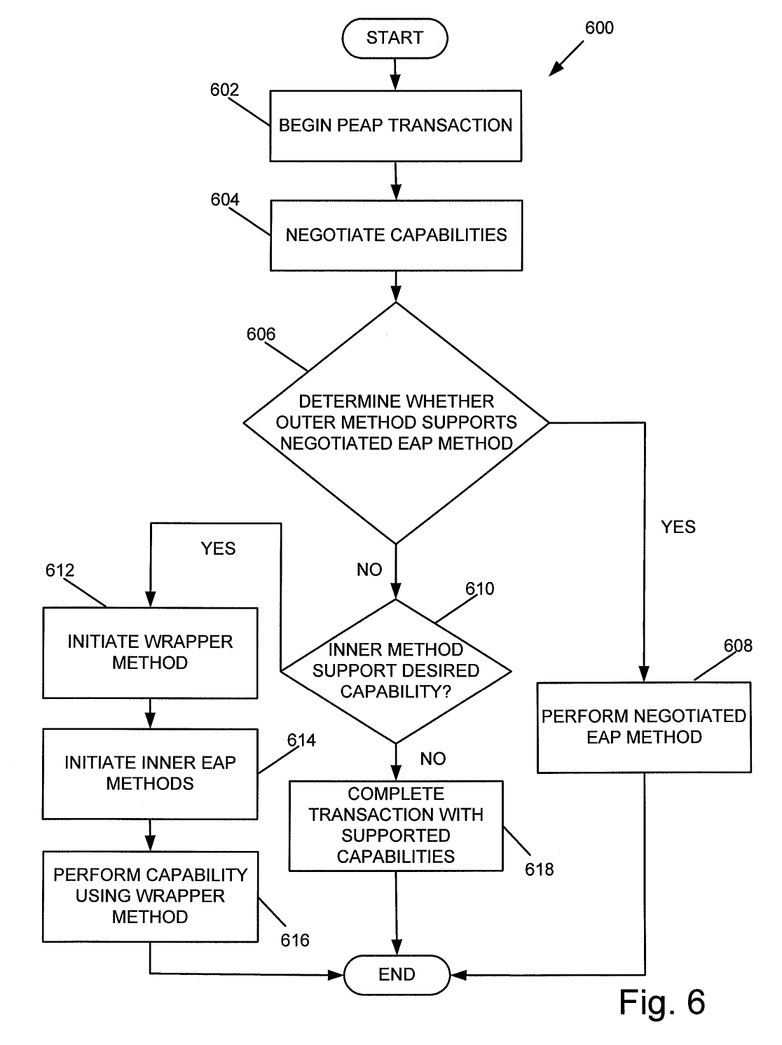

FIG. 6 is a flow chart illustrating an embodiment of a method 600 determining the capability supported by a receiving device and performing any unsupported capability. Flow begins at operation 602, where a PEAP transaction is initiated. One of skill in the art will appreciate that while FIG. 6 is described with respect to PEAP transactions, in other embodiments, any transaction between two endpoints that employ the Extensible Authentication Protocol. At operation 602, the secure tunnel is established between two end points using the outer method. Flow then proceeds to operation 604, where the capabilities of the EAP transaction are negotiated within the secure tunnel. In embodiments, the capabilities may be negotiated according to the embodiments described with respect to FIGS. 2 and 3. For example, a capability negotiation method may be used to determine whether the outer method supports a desired capability.

Flow proceeds to decision operation 606. At operation 606, a determination is made as to whether or not the outer method in the PEAP transaction supports the desired capabilities. If the desired capabilities are supported, flow branches YES to operation 608, where the PEAP transaction is completed using the desired capabilities. If the desired capabilities are not supported by the outer method in the PEAP transaction, flow branches NO to decision operation 610.

At decision operation 610, a determination is made as to whether or not the inner method in the PEAP transaction supports the desired capability. In embodiments, the capabilities of the inner method may be determined using the capabilities negotiation method described with respect to FIGS. 2 and 3. For example, the inner method may support a chaining capability. If the desired capability is chaining, the inner method may be used to perform the desired capability, as described with respect to FIG. 5.

If the inner method supports the desired capability, flow branches YES to operation 612. At operation 612, one end point requesting a specific capability generates a inner wrapper method. As described with respect to FIG. 5, the inner wrapper method will be supported by the outer method employed in the PEAP transaction. In embodiments, the inner wrapper method may be used as an additional tunnel to maintain and transport unsupported EAP methods that implement desired capabilities. Flow proceeds to operation 614, where one or more inner EAP methods are initiated to implement the desired capabilities. In embodiments, one capability may be the ability to chain together multiple EAP methods as described with regard to FIG. 5. Flow then proceeds to operation 616, where the initiated inner EAP methods perform the desired capabilities, even though the outer method employed in the PEAP transaction does not support such capabilities. In embodiments, the inner wrapper method may act only as a tunnel to transport the initiated inner EAP methods. In other embodiments, the inner wrapper method may also facilitate the execution of the inner EAP methods.

Referring again to decision operation 610, if the inner method does not support the desired capability, flow branches NO to operation 618. At operation 618, the PEAP transaction may be completed using the capabilities supported by the inner and outer EAP methods employed in the PEAP transaction instead of the desired capabilities. In other embodiments, the PEAP transaction may fail at operation 618. Using the disclosed methods, end points are able to negotiate the capabilities supported by the inner and outer methods in PEAP transactions. If a desired capability is not supported by the outer method employed by the PEAP transaction, the disclosed methods provide for performing the desired capabilities within a compatible inner wrapper method. While embodiments of the present disclosure have been illustrated with respect to PEAP, one of skill in the art will appreciate that the methods and systems disclosed herein are applicable to any type of EAP tunneling methods.

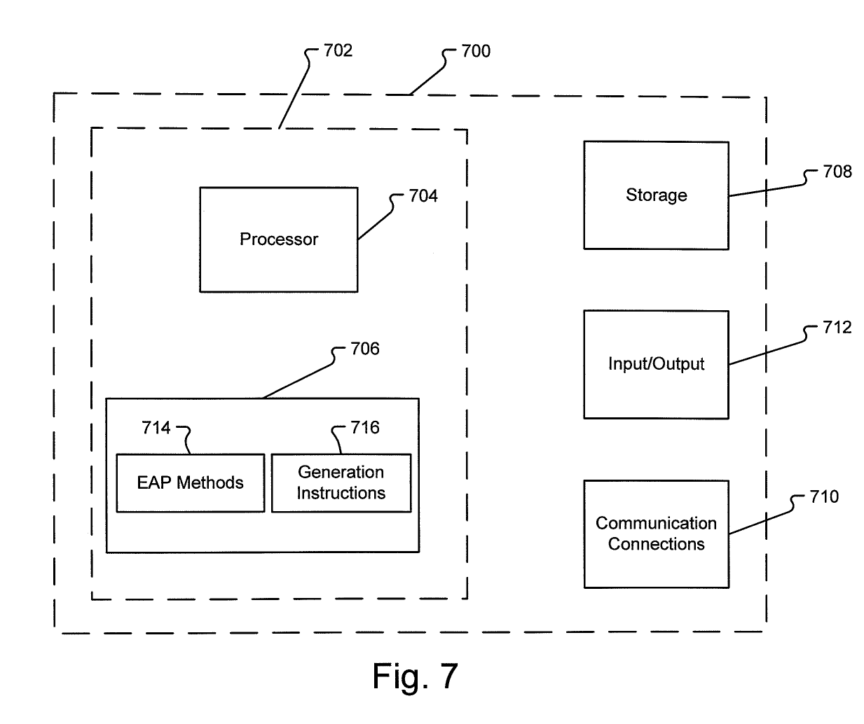

With reference to FIG. 7, an embodiment of a computing environment for implementing the various embodiments described herein includes a computer system, such as computer system 700. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 700 comprises at least one processing unit or processor 704 and system memory 706. The most basic configuration of the computer system 700 is illustrated in FIG. 7 by dashed line 702. In some embodiments, one or more components of the described system are loaded into system memory 706 and executed by the processing unit 704 from system memory 706. Depending on the exact configuration and type of computer system 700, system memory 706 may be volatile (such as RAM), non-volatile (such as ROM, flash memory, etc.), or some combination of the two.

Additionally, computer system 700 may also have additional features/functionality. For example, computer system 700 includes additional storage media 708, such as removable and/or non-removable storage, including, but not limited to, magnetic or optical disks or tape. In some embodiments, software or executable code and any data used for the described system is permanently stored in storage media 708. Storage media 708 includes volatile and non-volatile, removable and non-removable media implemented in any method or technology for storage of information such as computer readable instructions, data structures, program modules, or other data. In embodiments, the capability negotiation methods and wrapper inner methods are stored in storage media 708.

System memory 706 and storage media 708 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 700 and processor 704. Any such computer storage media may be part of computer system 700. In some embodiments, mammogram images and/or results of probability determination are stored in system memory 706. In embodiments, system memory 706 and/or storage media 708 stores data used to perform the methods or form the system(s) disclosed herein, such as generating well-defined messages, expressing a collective intent of security semantics, accepting and/or rejecting well-defined messages, etc. In embodiments, system memory 706 would store information such as EAP methods 714 and generation instructions 716. In embodiments, EAP methods 714 may be general EAP methods, capability negotiation methods, wrapper inner methods, or any other type of EAP methods. Generation instructions 716, in embodiments, store the instructions necessary to generate the EAP methods and/or perform the disclosed methods and systems. For example, generation instructions 716 may include functions or processes for generating a capability negotiation method, generating a wrapper inner method, etc.

Computer system 700 may also contain communications connection(s) 710 that allow the device to communicate with other devices. In embodiments, communications connection(s) 710 may be used to transmit and receive messages between sender devices, intermediary devices, and recipient devices. Communication connection(s) 710 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, EAP methods may be transmitted over the communication connection(s) 710.

In some embodiments, computer system 700 also includes input and output connections 712, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 712 are used to display the information as described herein. All these devices are well known in the art and need not be discussed at length here.

In some embodiments, the component described herein comprise such modules or instructions executable by computer system 700 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 700 is part of a network that stores data in remote storage media for use by the computer system 700.

This disclosure described some embodiments of the present disclosure with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. Therefore, the specific structure, acts, or media are disclosed only as illustrative embodiments. The disclosure is defined by the appended claims.

What is claimed is:

1. A computer storage medium encoding computer-readable instructions executable by a processor for performing a method of negotiating capability between a sender and a receiver during a EAP transaction, the method comprising:
initiating an EAP method at the sender, wherein the EAP method is used to negotiate capabilities supported by the sender and the receiver;
sending a request from the sender to the receiver using the EAP method;
receiving, at the sender, a response from the receiver;
in response to receiving a negative acknowledgement, determining a capability supported by the receiver; and
completing the EAP transaction implementing the capability supported by the receiver.

2. The method of claim 1, wherein the EAP method is for fragmentation negotiation.

3. The method of claim 2, wherein the request includes a packet for negotiating a maximum fragmentation size.

4. The method of claim 3, wherein the response specifies a maximum fragmentation size supported by the receiver.

5. The method of claim 1, wherein the request is an empty packet.

6. The method of claim 5, wherein the response is an empty packet announcing that the receiver supports the EAP method.

7. The method of claim 1, wherein the response is a negative acknowledgment that the receiver does not support the EAP method.

8. The method of claim 1, wherein the capabilities supported by the sender and the receiver correspond to the capabilities of an outer EAP method employed in the EAP transaction.

9. A method of chaining multiple inner authentication methods, the method comprising:
establishing a PEAP authentication session, wherein establishing the session comprises establishing a secure outer tunnel between a client and a server;
generating an inner wrapper method, wherein the inner wrapper method is a wrapper for multiple inner authentication methods;
chaining the multiple inner authentication methods within the inner wrapper method;
performing the multiple inner authentication methods for the client and the server, wherein the chaining of the multiple inner authentication methods is managed by the wrapper inner method.

10. The method of claim 9, wherein the secure outer tunnel does not support chaining of inner methods.

11. The method of claim 9, wherein the multiple inner authentication methods are performed without changing the secure outer tunnel.

12. The method of claim 9, wherein the chained multiple inner authentication methods are transported inside the inner wrapper method.

13. The method of claim 9, wherein the inner wrapper method allows the server to perform a capability not supported by an outer method of the PEAP authentication session.

14. The method of claim 13, wherein the inner method facilitates the execution of the multiple inner authentication methods.

15. A system for negotiating an EAP capability between computing devices, the system comprising:
a sender participating in a PEAP transaction, wherein the PEAP transaction comprises establishing a secure outer tunnel;
a receiver participating in the PEAP transaction;
a computer storage medium at the sender, wherein the computer storage medium encodes computer-readable instructions executable by a processor for performing a method comprising:
initiating an EAP capability negotiation method at the sender, wherein the EAP capability negotiation method is used to negotiate a desired capability supported by the outer method employed in the PEAP transaction;
sending a request from the sender to the receiver using the EAP capability negotiation method;
receiving, at the sender, a response from the receiver, wherein the response is generated at the receiver after receiving the request from the sender, the response further comprising a negative acknowledgement if the outer method does not support the desired capability;
determining, at the sender, whether an inner method employed in the PEAP transaction supports the desired capability;
if the inner method supports the desired capability, initiating an inner wrapper method, at the sender; and
performing the capability using the inner wrapper method.

16. The system of claim 15, wherein the desired capability comprises chaining two or more authentication methods.

17. The system of claim 16, wherein the inner wrapper method facilitates the chaining of the two or more authentication methods.

18. The system of claim 16, wherein the secure outer tunnel does not support the chaining.

19. The system of claim 15, wherein an EAP capability negotiation method is used to determine whether the inner method employed in the PEAP transaction supports the desired capability.

20. The system of claim 15, the negative acknowledgment provides a list of capabilities supported by the outer method.
